(19) United States
(12) Patent Application Publication
(10) Pub. No.: US 2020/0089786 A1
(43) Pub. Date: Mar. 19, 2020

(54) CLUSTERING TECHNIQUES TO AUTOMATICALLY CREATE GROUPS OF GEOGRAPHIC REGIONS

(71) Applicant: Microsoft Technology Licensing, LLC, Redmond, WA (US)

(72) Inventors: Xiang Cheng, Sunnyvale, CA (US); Chen Wang, Milpitas, CA (US); Michael J. Tambe, Redwood City, CA (US); Megh Mehta, Sunnyvale, CA (US); Xiaojing Dong, Sunnyvale, CA (US); Chi-Yi Kuan, Fremont, CA (US)

(21) Appl. No.: 16/136,024

(22) Filed: Sep. 19, 2018

(51) Int. Cl. G06F 17/30; G06F 15/18; G06K 9/62; G06Q 30/02

(52) U.S. Cl. CPC G06F 17/30241; G06Q 30/0205; G06K 9/6218; G06F 15/18

(57) ABSTRACT

Techniques for automatically creating geographic region groups are provided. Attribute data about a plurality of regions is stored. Based on the attribute data, each region is classified as belonging to a tier of multiple tiers. A first set of region groups is generated, where each region group includes at least two regions assigned to different tiers. For each region group, group attribute data for that region group is generated. A comparison of first group attribute data of a first region group is performed with group attribute data of each other region group. Based on results of the comparison, first arrangement data that associates a second region group with the first region group is stored.

### TECHNICAL FIELD

The present disclosure relates to machine learning and, more specifically, to using machine learning techniques to create groups of regions based on online activity.

### BACKGROUND

Today, many providers of services and products rely on electronic means to educate the individuals, groups, organizations, and the general public about those services and products. Such providers initiate content delivery campaigns where content items are distributed over the Internet and/or other distribution channels to end-user devices for presentation. Such content items may be targeted to specific users or groups of users or may be indiscriminate.

However, content distribution can be expensive. In such cases, it is imperative that distribution efforts are proven on a small scale prior to using those distribution efforts on a wide scale. Current approaches to measuring impact of a content distribution effort include tracking, surveying, ARIMA, and Media Mix Modeling (MMM).

Tracking involves adding a pre-assigned tracking code to a hyperlink in an email, search engine result, or sponsored update on an online network platform. When a user selects the hyperlink, this selection can be traced to the original tracking code which is associated with a particular content delivery campaign or other distribution effort. However, tracking is not available for offline channels, such as radio and television, where tracking information is difficult, if not impossible, to collect.

Surveying involves customers completing a survey in a checkout flow about which distribution effort impacted their decision. Disadvantages of this approach include an historically low participation rate, commonly inaccurate survey responses, and the near impossibility of measuring (with statistical confidence) incremental impact when organic conversions are high.

ARIMA (or Auto-Regressive Integrated Moving Average) uses time series data to predict future success. The difference between observed success and predicted success is regarded as the impact of a distribution effort. However, this method, while measuring overall impact of distribution effort, cannot provide information at a channel/campaign level. Also, important factors, such as new product features, pricing, and macro-economic factors are not captured by this method. Lastly, the predictions may be faulty, thus putting the reliability of the impact in question.

MMM is an analytical approach that uses historical information to quantity the impact of various distribution efforts. Mathematically, this is done by establishing a simultaneous relation of various distribution efforts with a success metric, in the form of a linear or a non-linear equation, through a statistical technique, such as regression. Drawbacks of MMM include: (1) a bias in favor of time-specific media (such as television commercials) versus less time-specific media (such as SEM); (2) because MMM uses spending data, the impact of low spending channels, such as email, may be underestimate if no adjustments made; and 3) since MMM uses spending data as a major input, other factors (e.g., content and targeting quality) are not sufficiently considered.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for creating groups of geographic regions based on online activity, in an embodiment;

FIG. 2 is a flow diagram that depicts a process for creating region groups based on online activity, in an embodiment;

FIG. 3 is an example graph that depicts an example result of a clustering step, in an embodiment;

FIG. 4 includes an example graph and example region groups based on the data points in the graph, in an embodiment;

FIG. 5 includes two charts: a chart that shows a number of instances of particular activity per region group per month over a (14-month) time period and a chart that shows ratios of that particular activity in each region group relative to a control region group over the same time period, in an embodiment;

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for creating groups of geographic regions based on online activity are provided. In one technique, region-specific attributes are generated for each geographic region. Region-specific attributes are used to assign each geography region to one of multiple tiers of. Then, one or more regions from each tier are identified and used to create a region group. Group performance data of one region group is generated and compared to group performance data of each of one or more other region groups. Based on the comparison, some region groups may be associated with each other for purposes of A/B testing one or more distribution efforts.

Embodiments improve computer technology and, specifically, the ability to measure the incremental impact of one or more distribution efforts. Embodiments are applicable to both online campaigns and offline campaigns. Embodiments leverage a clustering technique, a stratified sampling technique, and an A/A test method to set up treatment and control groups, which enables shorter experiment time in order to obtain a statistically significant outcome. With a customized A/B test setting, embodiments are able to measure a specific channel/campaign impact when other channels/campaigns are live at the same time.

### System Overview

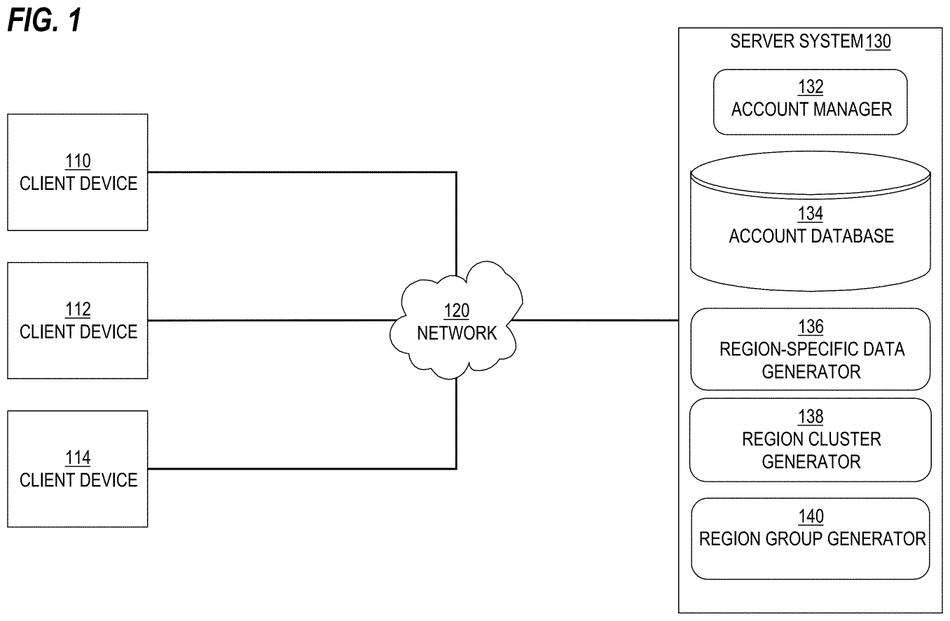

FIG. 1 is a block diagram that depicts an example system 100 for creating groups of geographic regions based on online activity, in an embodiment. System 100 includes client devices 110-114, network 120, and server system 130.

Each of client devices 110-114 communicates with server system 130 over network 120. Examples of client devices include a laptop computer, a tablet computer, a smartphone, a desktop computer, and a personal digital assistant (PDA). An example of an application that executes on a client device includes a dedicated application that is installed and executed on the client device and that is configured to communicate with server system 130 over network 120. Another example of an application is a web application that is downloaded from server system 130 and that executes within a web browser running on a client device. The application may be implemented in hardware, software, or a combination of hardware and software. Although only four client devices are depicted, system 100 may many more multiple clients that interact with server system 130 over network 120.

Through one of client devices 110-114, a user is able to transmit digital information to server system 130. Later, the user may employ the client device to interact with server 130 to retrieve, supplement, and/or update the digital information (or simply “data”).

Network 120 may be implemented on any medium or mechanism that provides for the exchange of data between client 110 and server system 130. Examples of network 120 include, without limitation, a network such as a Local Area Network (LAN), Wide Area Network (WAN), Ethernet or the Internet, or one or more terrestrial, satellite or wireless links.

### Server System

Although depicted as a single element, server system 130 may comprise multiple computing elements and devices, connected in a local network or distributed regionally or globally across many networks, such as the Internet. Thus, server system 130 may comprise multiple computing elements other than account manager 132 and account database 134. Account manager 132 creates or updates accounts based on data and instructions from client devices 110-114 where, for example, the account data is input by users (e.g., selecting characters on a physical or graphical keyboard) operating the client devices.

Account database 134 comprises information about multiples accounts. Account database 134 may be stored on one or more storage devices (persistent and/or volatile) that may reside within the same local network as server system 130 and/or in a network that is remote relative to server system. Thus, although depicted as being included in server system 130, each storage device may be either (a) part of server system 130 or (b) accessed by server system 130 over a local network, a wide area network, or the Internet.

In a social networking context, server system 130 is provided by a social network provider, such as LinkedIn, Facebook, or Google+. In this context, each account (of at least some accounts) in account database 134 includes a user profile, each provided by a different user. A user's profile may include a first name, last name, an email address, residence information, a mailing address, a phone number, one or more educational institutions attended, one or more current and/or previous employers, one or more current and/or previous job titles, a list of skills, a list of endorsements, and/or names or identities of friends, contacts, connections of the user, and derived data that is based on actions that the candidate has taken. Examples of such actions include jobs to which the user has applied, views of job postings, views of company pages, views of learning content, number of online (e.g., video) courses completed, messages between the user and other users in the user's social network, and public messages that the user posted and that are visible to users outside of the user's social network (but that are registered users/members of the social network provider).

Some data within a user's profile (e.g., work history, skills) may be provided by the user while other data within the user's profile (e.g., skills and endorsement) may be provided by a third party, such as a “friend,” connection, colleague of the user.

Server system 130 may prompt users to provide profile information in one of a number of ways. For example, server system 130 may have provided a web page with a text field for one or more of the above-referenced types of information. In response to receiving profile information from a user's device, server system 130 stores the information in an account that is associated with the user and that is associated with credential data that is used to authenticate the user to server system 130 when the user attempts to log into server system 130 at a later time. Each text string provided by a user may be stored in association with the field into which the text string was entered. For example, if a user enters “Sales Manager” in a job title field, then “Sales Manager” is stored in association with type data that indicates that “Sales Manager” is a job title. As another example, if a user enters “Java programming” in a skills field, then “Java programming” is stored in association with type data that indicates that “Java programming” is a skill.

In an embodiment, server system 130 stores access data in association with a user's account. Access data indicates which users, groups, or devices can access or view the user's profile or portions thereof. For example, first access data for a user's profile indicates that only the user's connections can view the user's personal interests, second access data indicates that confirmed recruiters can view the user's work history, and third access data indicates that anyone can view the user's endorsements and skills.

In an embodiment, some information in a user profile is determined automatically by server system 130 (or another automatic process). For example, a user specifies, in his/her profile, a name of the user's employer. Server system 130 determines, based on the name, where the employer and/or user is located. If the employer has multiple offices, then a location of the user may be inferred based on an IP address associated with the user when the user registered with a social network service (e.g., provided by server system 130) and/or when the user last logged onto the social network service.

Other types of accounts in account database 134 may be for organizations, such as companies, charitable organizations, academic institutions, government agencies, etc. Example attributes of such organizations may include, if applicable, a geographic location for their headquarters, contact information, size of organization, number of clients/customers served, revenue totals, profits, etc.

While many examples herein are in the context of social networking, embodiments are not so limited.

### Process Overview

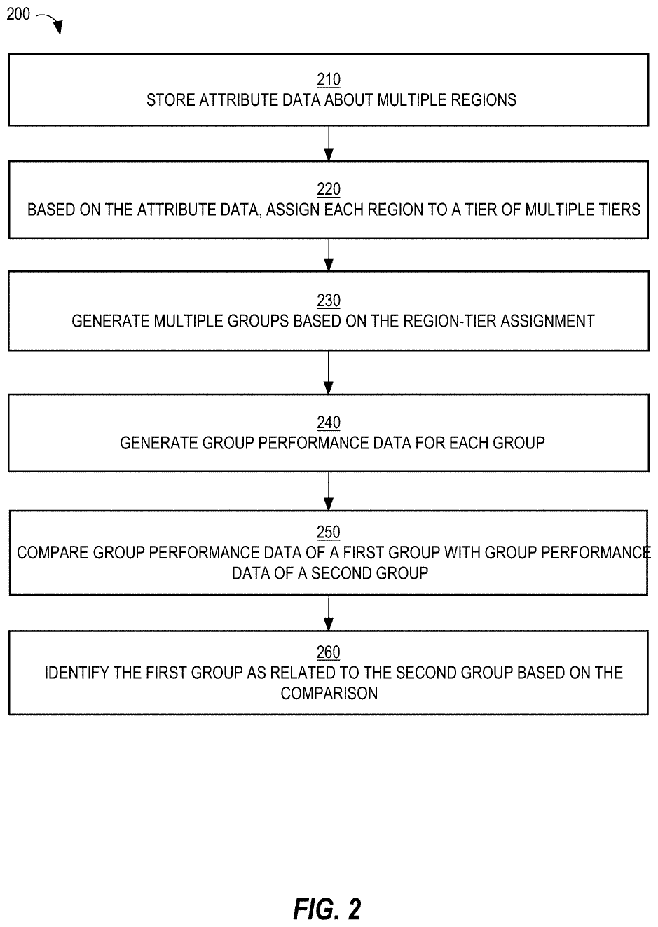

FIG. 2 is a flow diagram that depicts a process 200 for creating region groups based on online activity, in an embodiment.

At block 210, attribute data about multiple regions is stored. Examples of attribute data for a region include characteristic data and/or performance data. Examples of performance data of a region include a number of conversions in that region, page views by users associated with the region, a number of online selections of content items by users in that region, etc. Examples of characteristic data of a region include a number of users in that region, a number of users that satisfy certain criteria in that region, a number of companies of a certain size and/or of a certain industry in the region, etc.

At block 220, based on the attribute data, each region is assigned to (or classified as belonging to) a tier from among multiple tiers. After block 220, each tier is assigned at least one region. The number of tiers may be established based on user input or may be determined automatically, such as a number of tiers that results in the lowest variance, as is described in more detail below.

At block 230, multiple region groups are generated, where each region group includes at least two regions that are assigned to different tiers of the multiple tiers. For example, a particular region group includes region A assigned to tier 1 and region B assigned to tier 2.

At block 240, group performance data is generated for each region group. Block 240 may involve, for each region group, aggregating performance data (or a portion thereof) of the regions belonging to that region group. The group performance data may be a different type of performance data than any performance data used in block 220.

At block 250, a comparison between first group performance data of a first region group and second group performance data of a second region group is performed.

At block 260, based on the comparison, the second region group is identified as related to the first region group.

### Region-Specific Attribute Data

Server system 130 includes a region-specific data generator (RSDG) 136, which generates region-specific attribute data in one or more ways. For example, accounts in account database 134 may include a geographic location, such as a city, a county, a state, a province, and or a country. RSDG 136 stores region definition data that defines the boundaries of each geographic region of multiple geographic regions. For example, a SF Bay Area region may include cities such as Mountain View and Palo Alto, while an Oakland region may include cities such as Oakland and Alameda.

RSDG 136 (or another component of server system 130) analyzes account database 134 to associate each account with a particular region among multiple pre-defined regions. RSDG 136 may perform this function when the account is created or whenever the corresponding user updates geographic location information associated with the account.

After accounts in account database 134 are associated with (or assigned to) a region, RSDG 136 generates, for each region, region-specific attribute data by aggregating account information pertaining to that region. For example, a number of users that reside in a first region is totaled and a number of users that reside in a second region is totaled. As another example, some users are classified based on their online activity, such as a number of visits to a particular website (or set of websites) in a particular time period (e.g., week or month). If, for example, a user logged into a particular website a certain number of times in the last month, requested a particular number of user or company page views in the last month, responded to a particular type of message targeted to the user in the last month, and/or commented/shared/liked one or more postings presented to the user in the last month, then the user is classified as an “engaged” user. Thus, a total number of engaged users in each region may be determined.

As another example, each account indicates whether the corresponding user performed some action, such as clicking on a particular content item (or class of content items), visiting a particular company web page (or class of company web pages), signing up for a particular seminar (or any seminar), viewing a description of a particular event, purchasing a particular product or service, etc. Thus, RSDG 136 may aggregate account data from account database 134 to determine a number of users in each region that performed one of the above actions.

Other example metrics or counts that may be determined for each region include number of sessions with a website, number of conversions (e.g., signups, purchases, etc.), number of job applicants, number of “qualified” users (e.g., users that have filled out a certain portion or amount of their respective user profiles), number of engaged users, number of users that satisfy multiple criteria (e.g., engaged and qualified), number of job listings, number of job applications, number of total social network connections, and number of feed interactions (e.g. likes, comments, shares).

RSDG 136 may calculate a single metric or value for each region of multiple regions or may calculate multiple metrics or values for each region. For example, for each region, RSDG 136 calculates a number of qualified users from that region and number of users that clicked on a content item from a particular content delivery campaign.

### Clustering

Server system 130 includes a region cluster generator (RCG) 138 that generates clusters of regions based on region-specific attribute data generated by RSDG 136. RCG 138 clusters or groups two or more regions into the same cluster based on how similar their respective region-specific attribute data is to each other. The number of regions in each cluster may vary from cluster to cluster. For example, one cluster comprises four regions that are deemed similar to each other while another cluster comprises nine regions that are deemed similar to each other.

RCG 138 may implement one or more techniques to perform the clustering. One example technique is k-means clustering, which is an unsupervised machine learning method of vector quantization. In k-means clustering, given a set of observations (x₁, x₂, . . . , xₙ), where each observation is a d-dimensional real vector, k-means clustering aims to partition the n observations (in this example, n regions) into k (≤n) sets (or clusters) S={S₁, S₂, . . . , Sₖ} so as to minimize the within-cluster sum of squares (WCSS) (i.e., variance). The d dimensions correspond to the different types of region-specific attribute data. Formally, the objective is to find:

$${arg min}_{S} {\sum }_{i = 1}^{k} {\sum }_{x ∈ {S}_{i}} {‖ x - {μ}_{i} ‖}^{2} = {arg min}_{S} {\sum }_{i = 1}^{k} \vert {S}_{i} \vert Var {S}_{i}$$

where μᵢ is the mean of points in Sᵢ. This is equivalent to minimizing the pairwise squared deviations of points in the same cluster:

$${arg min}_{S} {\sum }_{i = 1}^{k} \frac{1}{2 \vert {S}_{i} \vert} {\sum }_{x , y ∈ {S}_{i}} {‖ x - y ‖}^{2}$$

Because the total variance is constant, this is also equivalent to maximizing the sum of squared deviations between points in different clusters (between-cluster sum of squares, BCSS).

Another example clustering technique involves computing a cosine similarity or a Euclidian distance for each pair of vectors, each vector corresponding to a different region. Each vector comprises an ordered set of values, each corresponding to a different type of region-specific attribute data. Cosine similarity is a measure of similarity between two non-zero vectors of an inner product space that measures the cosine of the angle between them. Euclidean distance is a straight-line distance between any two points.

The number of clusters that are created may be based on user input that specifies a particular number (e.g., four) or specifies a range of values (e.g., two to ten). If a range is specified, then RCG 138 determines a number of clusters in that range that has the lowest error by calculating an error of each possible cluster. If user input is not specified, then RCG 138 may determine a number of clusters based on a number of regions that are defined and test a different number of clusters based on that number. For example, if there are one hundred regions, then RCG 138 tries 3 clusters up to 25 clusters (i.e., one quarter of one hundred).

It may seem that as the number of clusters increases, the calculated error decreases, which would mean that the greatest possible number of clusters will always be chosen. However, this is addressed by taking into account a marginal benefit. The number of clusters ceases to increase when the marginal benefit is lower than a particular threshold. The particular threshold is related to the data and the setup of the experiment. The marginal benefit may be defined as WCSS(n)-WSCC(n−1), where n is the number of clusters and WSCC is an acronym for Within-Cluster Sum of Squares. The value of WCSS(n)-WSCC(n−1) should become smaller as n becomes larger. A method to select the number of clusters is referred to as the “elbow method.” The elbow method is a method of interpretation and validation of consistency within cluster analysis designed to help finding an appropriate number of clusters in a dataset. This method looks at the percentage of variance explained as a function of the number of clusters: a number of clusters is chosen so that adding another cluster does not give much better modeling of the data. If one plots a percentage of variance explained by the clusters against the number of clusters, then the first clusters will add much information (explain a lot of variance), but at some point the marginal gain will drop, giving an angle in the graph. The number of clusters is chosen at this point, hence the “elbow criterion.”

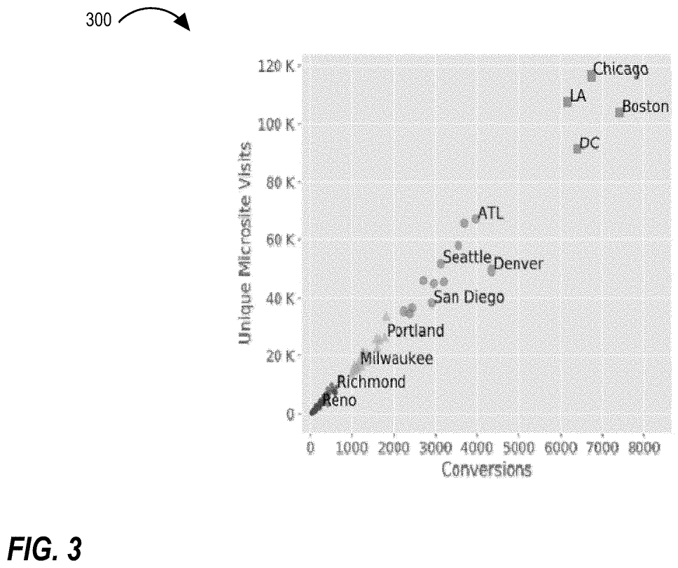

FIG. 3 is an example graph 300 that depicts an example result of the clustering step. Each point on graph 300 corresponds to a different region. Some points are labeled with their corresponding city/region name. The points in the two-dimensional space are based on two types of region-specific performance data: number of conversions (on the x-axis) and number of unique website visits (on the y-axis). These values may be based on a particular time period, such as the last month, the last six months, or the last year. In this example, the regions represented by the four points at the top-right portion are assigned to one cluster, the regions represented by the points between two thousand conversions and five thousand conversions are assigned to another cluster, the regions represented by the points between one thousand conversions and two thousand conversions are assigned to another cluster, and the remaining regions are assigned to yet another cluster. Thus, in this example, there are four clusters or “tiers”: large metro (e.g., Boston, Chicago), “big” regions (e.g., Atlanta and Denver), “medium” regions (e.g., Portland and Milwaukee), and “small” regions (e.g., Reno).

### Stratified Sampling

Once the clusters or tiers are formed, a goal is to form groups of regions that are similar to each other in terms of one or more dimensions or factors, such as number of conversions, number of unique visits, and revenue or sales amount. A challenge is that the regions are very different from each other in terms of these metrics. For example, Seattle is five times larger than Reno. Each experimental group should be assigned a fair allocation of regions from each cluster or tier.

In an embodiment, server system 130 includes a region group generator (RGG) 140. RGG 140 generates region groups that include regions from two or more (or all) clusters or tiers. For example, if there are four clusters, then each region group may include at least one region from each cluster. The number of region groups may be limited by the number of regions assigned to the least populated cluster. In the above example, since there are only four regions in the smallest cluster, then either two or four region groups are created.

The process of creating region groups by selecting regions from among multiple clusters is referred to as “stratified sampling.” One example stratified sampling technique may involve, given a number of region groups to create (which may be based on user input), for each cluster, divide the number of regions in the cluster by the number of region groups. If the result of the division is a whole number, then that number of regions in the cluster is randomly selected from the cluster and assigned to a region group. For example, if the result of the division is 3, then 3 regions from the cluster are randomly selected and assigned to one region group, a different 3 regions from the cluster are randomly selected and assigned to another region group, and so forth. If the result of the division is not a whole number, such as 4.6, then some region groups will be assigned a number of regions equal to the ceiling of the result (e.g., 5) while other region groups will be assigned a number of regions equal to the floor of the result (e.g., 4).

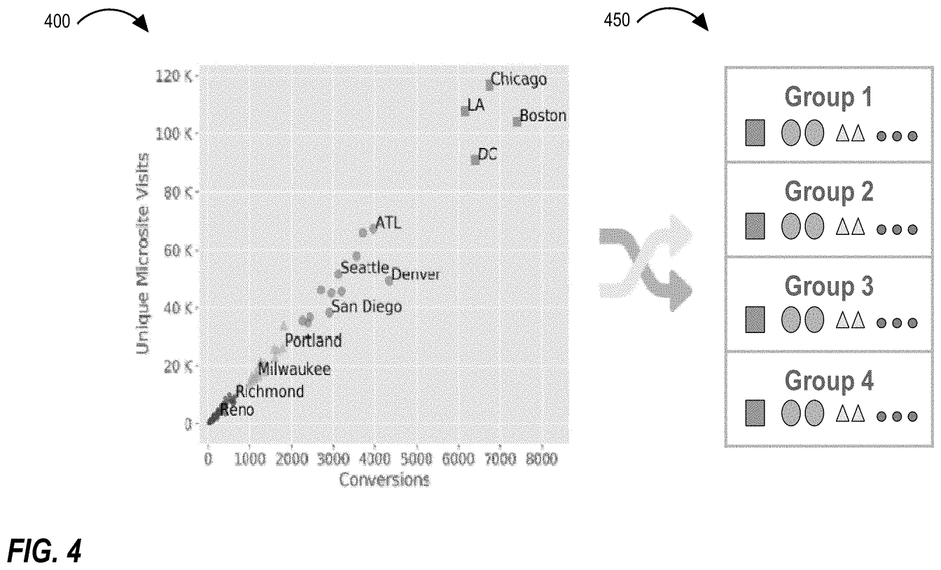

FIG. 4 includes an example graph 400 and example region groups 450 based on the data points in graph 400, in an embodiment. Graph 400 mirrors graph 300. Each data point is associated with a shape that indicates a tier or cluster to which the corresponding region is assigned. In this example, as reflected in region groups 450, each region group is assigned one region from tier 1, two regions from tier 2, three regions from tier 3, and three regions from tier 4.

A set of distinct region groups that RGG 140 generates is referred to as an “arrangement.” For example, the four region groups in region groups 450 constitute an arrangement.

Each iteration of stratified sampling results in a different arrangement. For example, (1) a first iteration results in a first arrangement that comprises group 1-A, group 1-B, and group 1-C; (2) a second iteration results in a second arrangement that comprises group 2-A, group 2-B, and group 2-C; (3) groups 1-A and 2-A are identical; (4) groups 1-B and 2-B are similar except that a region that is assigned to group 1-B in the first arrangement is assigned to group 2-C in the second arrangement; and (5) groups 1-C and 2-C are similar except that a region that is assigned to group 1-C in the first arrangement is assigned to group 2-B in the second arrangement. If a subsequent iteration results in an arrangement that is identical to a previous iteration, then that arrangement is ignored.

### A/A Test

After an arrangement is created, one of the region groups in the arrangement is selected as the control group and the remaining region groups are considered treatment groups.

RGG 140 (or another component of server system 130) conducts tests to verify that the region groups formed by RGG 140 are similar enough to one another. Such a similarity determination may be based on comparing one or more group characteristics of each region group to each other. Examples of group characteristics include one or more types of region-specific performance data, which may have been used to assign regions to tiers/clusters, such as number of conversions.

In an embodiment, similarity may be determined by, for each treatment group, calculating one or more ratios of a group characteristic of the control region group with a group characteristic of a treatment group. Using ratios instead of group characteristic directly has multiple advantages. For example, comparing a group characteristic of each region group does not pass the normality test, but using multiple ratios reflecting a relationship between region groups does. Also, using ratios has a higher likelihood of avoiding macro factors (e.g., seasonality and macro-economic factors) that affect both treatment and control groups compared with using a group characteristic directly. The group characteristic of the control group is used as the denominator while the numerator of the ratio comes from the group characteristic of a treatment group.

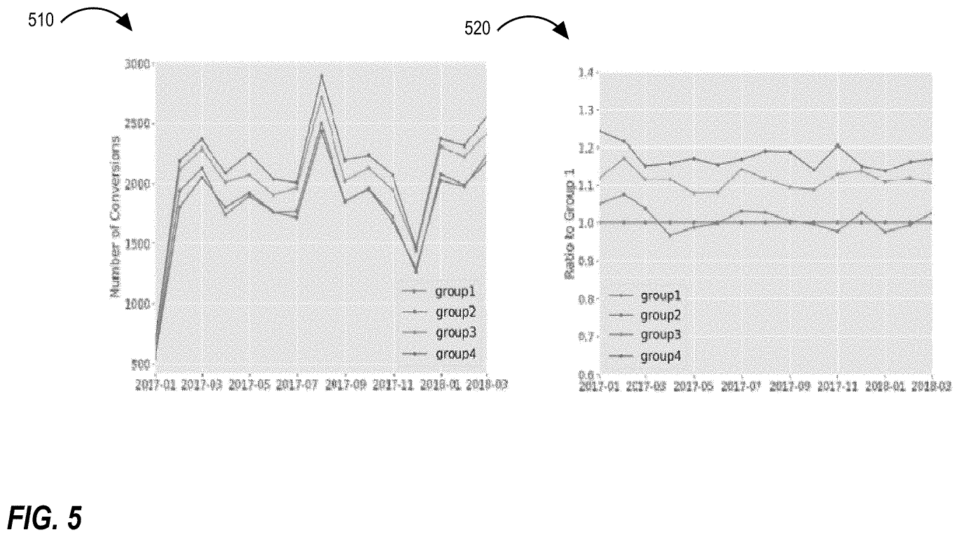

FIG. 5 includes (1) a chart 510 that shows a number of conversions per region group per month over a (14-month) time period and (2) a chart 520 that shows ratios of conversions of each region group relative to a control region group over the same time period. In this example, for purposes of this A/A test, region group 1 is considered the control group and region groups 2-4 are considered treatment groups. If there are 14 time periods, then 14 ratios are computed.

Even though ratios with respect to a treatment group may be different and even though the ratios may be (e.g., much) greater than or less than 1, if the ratios are consistent or stable over time, then the treatment group and the control group may be confidently used for AB testing. In an embodiment, for each treatment group, a confidence interval is defined (e.g., ±5%) around the mean or median ratio of a group characteristic of that treatment group relative to the group characteristic of the control group. If each ratio with respect to the treatment group and the control group is within the confidence interval, then the ratios of the treatment group are considered stable. If all treatment groups pass this confidence interval test relative to the control group, then this arrangement of region groups (both control and treatment groups) is a candidate arrangement. If one control group-treatment group A/A test fails, then all possible combinations of control groups and treatment groups for that arrangement would fail the A/A test and stratified sampling would be redone.

As another noted above, multiple arrangements of region groups may be generated using stratified sampling. For example, RGG 140 generates different arrangements and performs a series of A/A tests for each arrangement to determine whether, for each arrangement, the region groups of the arrangement are similar enough as indicated by each set of ratios of each treatment group relative to a control group. For example, a first arrangement of region groups includes group 1-A, group 1-B, group 1-C, and group 1-D. A second arrangement of region groups includes group 2-A, group 2-B, group 2-C, and group 2-D. At least one region group in the second arrangement is different than each region group in the first arrangement. For example, group 2-A may be identical to group 1-A and group 2-B may be identical to group 1-B; however, group 2-C is different than each region group in the first arrangement.

After testing a set of arrangements, only a strict subset may be candidates. For example, if there is only one candidate arrangement, then that arrangement is selected for A/B testing. If multiple candidate arrangements are identified as a result of the A/A testing, then the candidate arraignment that had the best result in the A/A testing may be selected for A/B testing. The best result may be reflected in the lowest mean or median variance of ratios with respect to a mean or median ratio or with the smallest mean or median ratio range between the maximum ratio and the minimum ratio. For example, the median ratio for a first treatment group with respect to a control group is 1.3, the highest ratio is 1.35, and the lowest ratio is 1.26. With respect to a second treatment group and the control group, the median ratio is 1.8, the highest ratio is 1.92, and the lowest ratio is 1.77. With respect to a third treatment group and the control group, the median ratio is 2.2, the highest ratio is 2.31, and the lowest ratio is 2.14. The first variance between the highest ratio and the lowest ratio for the first treatment group is between 1.038 and 0.969; the second variance between the highest ratio and the lowest ratio for the second treatment group is between 1.067 and 0.983; the third variance between the highest ratio and the lowest ratio for the third treatment group is between 1.05 and 0.973. The mean variance is ˜0.077 (i.e., (0.0772+0.084+0.069)/3). In an embodiment, the arrangement that has the lowest mean (or median, or other percentile) variance is selected for A/B testing.

If there are no candidate arrangements after all (or multiple) arrangements have been tested, then the clustering technique may be performed again except that a different number of tiers is enforced. For example, if four clusters or tiers were identified as a result of the first clustering performance, then the second clustering performance identifies three or five tiers and assigns each region to one of these tiers.

### A/B Testing

Once an arrangement is selected for A/B testing, the A/B testing may begin. One or more of the region groups in the arrangement are considered control groups and the remaining region groups are considered the treatment groups. For example, if there are four region groups, then one is considered the treatment group where one or more distribution efforts are implemented and the other three region groups are the control groups where the one or more distribution efforts are not implemented. Example distribution efforts include online and offline efforts. Example online (or digital) efforts include search engine marketing (e.g., purchasing one or more keywords and displaying content items pertaining to a content delivery campaign if a user query includes one of the one or more keywords), social network marketing (e.g., creating one or more content delivery campaigns that target certain user segments defined by one or more targeting criteria), and email. Example offline (or non-digital) efforts include radio, TV, and direct mail.

Distribution efforts are implemented in regions assigned to one or more treatment groups. One or more metrics are tracked in both the treatment group(s) and the control group(s), such as unique website visitors, conversions, bookings, user selections (e.g., clicks), etc. If there is a lift in the ratio after the distribution effort launched, then it can be concluded that the distribution effort had a positive impact. For example, if the ratio of (1) the tracked metric (e.g., number of conversions) of a treatment group to (2) the tracked metric of a control group is greater than the largest ratio (or the mean or media ratio) from A/A testing of that treatment group-control group combination, then there is high confidence that at least that difference is a result of the distribution effort(s) in the treatment group.

As a specific example of a multivariate A/B test, no distribution effort is made in a control group, a distribution effort is made through a first electronic channel (e.g., a particular search engine) in a first treatment group, a distribution effort is made through a second electronic channel (e.g., a particular social network provider) in a second treatment group, and a distribution effort is made through both the first and second electronic channels in a third treatment group. Multiple key metrics that are tracked in each group include number of page visits, number of conversions, and number of bookings. The tracking may occur for a period of time, such as a few days, a week, or a month. After the period of time has elapsed, for each treatment group, a ratio of a key metric of the treatment group and the control group is determined and compared to one or more ratios computed before the A/B test began. If there is a significant lift (or increase) in the ratio after the A/B test, then it is presumed that a primary reason for the lift is the corresponding distribution effort(s).

### Large-Scale A/B Testing V. Small-Scale A/B Testing

A large-scale A/B test, such as one that involves an entire Country (e.g., U.S., China), Continent (e.g., Africa), or group of countries (e.g., Europe) has advantages and disadvantages compared to a small-scale A/B test. An advantage is that groups of regions lower the minimal detectable effect. In other words, relatively small changes as a result of one or more new distribution efforts can be detected using groups of regions. A disadvantage of a large-scale A/B test that involves multiple region groups is that it is difficult to exclude other factors in so many regions.

In an embodiment, a small-scale A/B test is conducted where one or more characteristics of region-specific performance data are compared to each other (e.g., computing ratios) during an A/A test instead of comparing group performance data of different region groups. In this embodiment, instead of stratified sampling, two regions are randomly sampled and one is considered as a control region and another as a treatment region. If the variance over time of a ratio of a key metric or characteristic between the treatment region and the control region is minimal (e.g., within a certain confidence level), then the two regions are selected for A/B testing.

### Internal Tool

In an embodiment, techniques described herein are implemented in an electronic tool that is used by an entity or organization that is marketing one or more products/services across multiple regions. The organization has access to region-specific attribute data for clustering regions and performance data for A/A testing.

In another embodiment, the electronic tool is hosted by one entity or organization and leveraged by other entities or organizations, such as product manufacturers, service providers, or advertisers. For example, the electronic tool is (at least partially) implemented as a web application. A representative of a service provider uses a computing device to download the web application that displays selectable options, each corresponding to a region (or group of regions) where the service provider may attempt one or more distribution efforts to determine whether there is a significant increase in one or more metrics. For example, the service provider may elect to use a content delivery service provided by the hosting entity to create a content delivery campaign that targets users (e.g., with certain attributes) in one or more treatment regions (or groups of regions) selected by the service provider, but not in one or more control regions.

The region-specific attribute data that is used to cluster regions and the performance data that is used perform A/A testing and AB testing may be provided by the service provider to the hosting entity or may be determined by the hosting entity. In this approach, third-party entities, such as advertisers or product/service providers, can see how their distribution efforts (e.g., online or offline campaigns) perform in certain (treatment) regions before implementing those distribution efforts in other (e.g., control) regions. The hosting entity may perform clustering, sampling, and A/A testing to determine which regions (or groups of regions) to present, to the service provider, as options for selecting as the treatment region/group and/or the control region/group.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

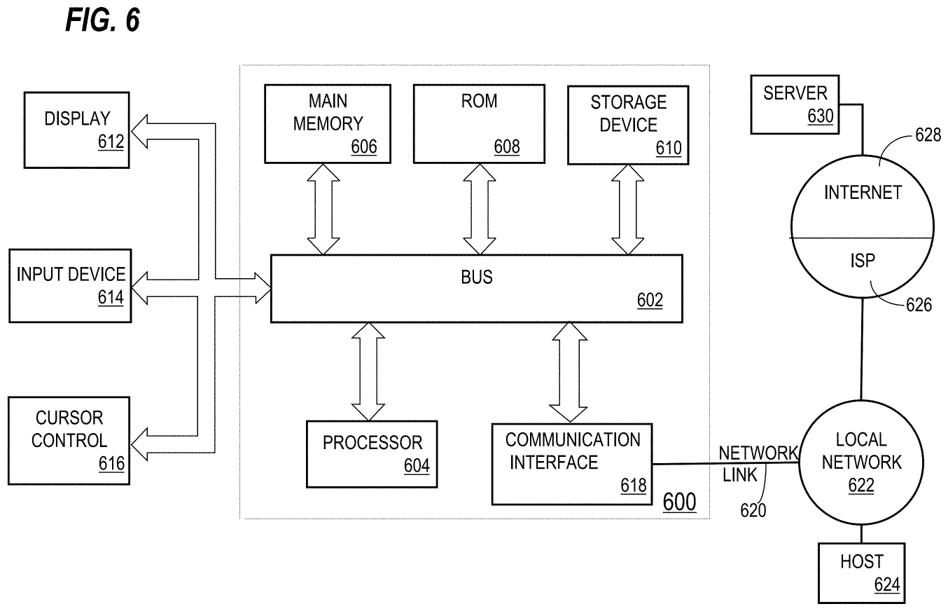

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing attribute data about a plurality of regions;
based on the attribute data, classifying each region of the plurality of regions as belonging to a tier of a plurality of tiers;
generating a first plurality of region groups, each region group comprising at least two regions assigned to different tiers of the plurality of tiers;
for each region group of the first plurality of region groups, generating group attribute data for said each region group;
performing a comparison of first group attribute data of a first region group of the first plurality of region groups with the group attribute data of each other region group of the first plurality of region groups;
based on results of the comparison, storing first arrangement data that associates a second region group, of the first plurality of region groups, with the first region group;
wherein the method is performed by one or more computing devices.

2. The method of claim 1, further comprising:
generating a second plurality of region groups, each region group comprising at least two regions assigned to different tiers of the plurality of tiers;
wherein the second plurality of region groups is different than the first plurality of region groups;
for each region group of the second plurality of region groups, generating second group performance data for said each region group;
performing a second comparison of (c) first particular group performance data of a third region group of the second plurality of region groups with (d) the particular group performance data of each other region group of the second plurality of region groups;
based on seconds results of the second comparison, determining whether to associate a fourth region group, of the second plurality of region groups, with the third region group.

3. The method of claim 2, further comprising:
storing second arrangement data that associates the third region group with the fourth region group;
based on the first arrangement data and the second arrangement data, determining which arrangement to use for A/B testing.

4. The method of claim 1, wherein:
the first group attribute data comprises a first plurality of data values and the group attribute data of each other region group comprises a second plurality of data values;
performing the comparison comprises:
for each time period of a plurality of time periods, computing a ratio of a first data value in the first plurality of data values and a second data value in the second plurality of data values;
a plurality of ratios are computed based on the comparison;
determining whether the plurality of ratios satisfy one or more criteria;
storing the first arrangement data is performed only in response to determining that the plurality of ratios satisfy the one or more criteria.

5. The method of claim 4, wherein the plurality of ratios satisfy the one or more criteria if a measure of variance among the plurality of ratios is below a particular threshold.

6. The method of claim 1, wherein attribute data comprises first attribute data about a first region in the plurality of regions, wherein the first attribute data comprises one or more of: a number of conversions by users associated with the first region in each time period of a plurality of time periods, a number of page views by the users associated with the first region in each time period of the plurality of time periods, a number of unique website visits by the users associated with the first region in each time period of the plurality of time periods, or a number of online selections of content items by the users associated with the first region.

7. The method of claim 1, wherein classifying comprises using one or more machine learning clustering techniques to assign each of region of the plurality of regions to one of the plurality of tiers.

8. The method of claim 1, further comprising:
for each region of the plurality of regions, generating a vector that comprises an ordered set of feature values, each corresponding to a characteristic of said each region and corresponding to a different feature of a plurality of features, wherein the vector is input to the one or more machine learning clustering techniques.

9. The method of claim 1, wherein the plurality of region groups includes a third region group that is different than the first region group and the second region group, wherein the first arrangement data associates all the region groups in the plurality of region groups with each other.

10. The method of claim 1, further comprising:
based on the first arrangement data, initiating a test to determine an effect that a distribution effort might have in the second region group, wherein the test involves implementing the distribution effort in the second region group but not in the first region group.

11. A method comprising:
storing attribute data about a plurality of regions, wherein the attribute data for each region of the plurality of regions comprises a plurality of data values, each corresponding to a different time period of a plurality of time periods;
selecting, from the plurality of regions, a first region and a second region that is different than the first region;
based on the attribute data, identifying first attribute data about the first region and second attribute data about the second region, wherein the first attribute data comprises a first plurality of data values and the second attribute data comprises a second plurality of data values;
performing a comparison of first attribute data with the second attribute data, wherein performing the comparison comprises, for each time period of the plurality of time periods, computing a ratio of a first data value in the first plurality of data values and a second data value in the second plurality of data values;
wherein a plurality of ratios are computed based on the comparison;
determining whether the plurality of ratios satisfy one or more criteria;
in response to determining that the plurality of ratios satisfy the one or more criteria, storing association data that associates the first region with the second region;
wherein the method is performed by one or more computing devices.

12. One or more storage media storing instructions which, when executed by one or more processors, cause:
storing attribute data about a plurality of regions;
based on the attribute data, classifying each region of the plurality of regions as belonging to a tier of a plurality of tiers;
generating a first plurality of region groups, each region group comprising at least two regions assigned to different tiers of the plurality of tiers;
for each region group of the first plurality of region groups, generating group attribute data for said each region group;
performing a comparison of first group attribute data of a first region group of the first plurality of region groups with the group attribute data of each other region group of the first plurality of region groups;
based on results of the comparison, storing first arrangement data that associates a second region group, of the first plurality of region groups, with the first region group.

13. The one or more storage media of claim 12, further comprising:
generating a second plurality of region groups, each region group comprising at least two regions assigned to different tiers of the plurality of tiers;
wherein the second plurality of region groups is different than the first plurality of region groups;
for each region group of the second plurality of region groups, generating second group performance data for said each region group;
performing a second comparison of (c) first particular group performance data of a third region group of the second plurality of region groups with (d) the particular group performance data of each other region group of the second plurality of region groups;
based on seconds results of the second comparison, determining whether to associate a fourth region group, of the second plurality of region groups, with the third region group.

14. The one or more storage media of claim 13, wherein the instructions, when executed by the one or more processors, further cause:
storing second arrangement data that associates the third region group with the fourth region group;
based on the first arrangement data and the second arrangement data, determining which arrangement to use for A/B testing.

15. The one or more storage media of claim 12, wherein:
the first group attribute data comprises a first plurality of data values and the group attribute data of each other region group comprises a second plurality of data values;
performing the comparison comprises:
for each time period of a plurality of time periods, computing a ratio of a first data value in the first plurality of data values and a second data value in the second plurality of data values;
a plurality of ratios are computed based on the comparison;
determining whether the plurality of ratios satisfy one or more criteria;
storing the first arrangement data is performed only in response to determining that the plurality of ratios satisfy the one or more criteria.

16. The one or more storage media of claim 15, wherein the plurality of ratios satisfy the one or more criteria if a measure of variance among the plurality of ratios is below a particular threshold.

17. The one or more storage media of claim 12, wherein attribute data comprises first attribute data about a first region in the plurality of regions, wherein the first attribute data comprises one or more of: a number of conversions by users associated with the first region in each time period of a plurality of time periods, a number of page views by the users associated with the first region in each time period of the plurality of time periods, a number of unique website visits by the users associated with the first region in each time period of the plurality of time periods, or a number of online selections of content items by the users associated with the first region.

18. The one or more storage media of claim 12, wherein classifying comprises using one or more machine learning clustering techniques to assign each of region of the plurality of regions to one of the plurality of tiers.

19. The one or more storage media of claim 12, wherein the instructions, when executed by the one or more processors, further cause:
for each region of the plurality of regions, generating a vector that comprises an ordered set of feature values, each corresponding to a characteristic of said each region and corresponding to a different feature of a plurality of features, wherein the vector is input to the one or more machine learning clustering techniques.

20. The one or more storage media of claim 12, wherein the plurality of region groups includes a third region group that is different than the first region group and the second region group, wherein the first arrangement data associates all the region groups in the plurality of region groups with each other.
